(19) United States
(12) Patent Application Publication
(10) Pub. No.: US 2025/0355723 A1
(43) Pub. Date: Nov. 20, 2025

(54) ORGANIZING UTILIZATION OF RESOURCES IN A COMPUTING ENVIRONMENT

(71) Applicant: International Business Machines Corporation, Armonk, NY (US)

(72) Inventor: Muhammad Usman Karim Khan, Sindelfingen (DE)

(21) Appl. No.: 18/746,455

(22) Filed: Jun. 18, 2024

(30) Foreign Application Priority Data
May 16, 2024 (GB) 2406944.5

(51) Int. Cl. G06F 9/50

(52) U.S. Cl. CPC G06F 9/5077

(57) ABSTRACT

The invention relates to a computer-implemented method of organizing utilization of a plurality of resources in a computing environment logically partitioned in layers, the method comprising, by a computer system configured for implementing a first layer: identifying a plurality of consumers of the resources on a second layer subsequent to the first layer; for each of the resources: obtaining from a resource model a prediction of an available quota of the resource based on a configuration of the consumers; logically subdividing the available quota into chunks; for each of the consumers: obtaining a correlation matrix of utilization rates of each resource measured for the consumer; generating a resource package specific to the consumer, the generation comprising selecting, based on the correlation matrix, a number of the chunks obtained for each resource, and adding the selected chunks to the resource package; and allocating the resource package to the consumer.

### BACKGROUND

The present invention relates to organizing utilization of resources in a computing environment.

Organized computing environments typically contain multiple computer systems that commonly access, or consume, resources that are available within the computing environment. Similarly, resources may be available to or within a single computer system that runs processes or other consumers having a common access to the resources. In these and similar other scenarios, it may be useful to distribute a quota of a resource that is available at a particular position within the computing environment among multiple consumers connected to that position. In an optimal scenario, each consumer receives a portion of each available resource that is sufficient for all conditions of resource utilization that may occur during its respective runtime.

However, several circumstances may cause difficulties, especially when organizing utilization of multiple resources to multiple consumers across multiple branches. One such circumstance may be that resource budgets may have a dynamic behavior. It may be difficult to determine the right quota for each consumer for a given resource. For example, consider a disk with a theoretical maximum bandwidth provided by the manufacturer. However, the real or available bandwidth is not pre-determined because the disk bandwidth is dependent upon multiple factors like the block sizes that the consumers will use, depth of the buffers and other factors that cannot be accounted for in many scenarios such as a cloud computing network. The disk input/output (I/O) performance may vary with the block size over multiple orders of magnitude. Therefore, before the startup of the consumers has been enabled, it may be wrong to partition the bandwidth, and assign the bandwidth quotas to the consumers.

Another possible issue is that resources may be not mutually exclusive. In the example above, assigning only the bandwidth would not be enough typically. It may rather be necessary to assign CPU and network resources together with the disk bandwidth, because it is possible that only assigning disk bandwidth would not help the consumer increase the utilization of the disk. In fact, to increase the disk bandwidth, the consuming process or system might also need some more processing capacity as well as some network bandwidth.

Another issue may arise from technical requirements such as the quality of service (Qos) that may be imposed on the computing environment for technical, business, legal or other reasons. In a shared infrastructure with multiple virtualized applications trying to access the physical resources, it may become very difficult to guarantee a certain QoS to the end user. Often, some virtual servers may get more resources, while others may get less resources depending upon the workload, number and configuration of neighbors, topology, etc. Thus, it may be very difficult for, e.g., a cloud provider to guarantee that virtual server instances will deliver a consistent QoS or performance over time.

Changing resource overcommitment levels over time may add further complication. Over a given contract period, no one may know if the arranged resource overcommit ratios will hold. In many cases, the price-performance models may not hold.

Parallel running customer workloads in neighboring virtual servers may also impact the QoS or performance guarantees. A cloud provider may do customer service level agreement (SLA) calculations either too optimistically (overprovisioning) or too pessimistically (underprovisioning) if the resource overcommitment level or the utilization of the system are changing.

For end-user satisfaction, stable QoS or performance throughout the life of the consumers (e.g., virtual servers) may be important although the infrastructure provider might add or remove consumers from the shared infrastructure. If the SLA or performance of an end user is not met, it may become necessary to migrate the end user to a bigger virtual server with more resources. If the SLA or performance of a consumer is overachieved, the end user may want to move to a smaller instance to save costs. However, migration might not be possible or result in unacceptable downtimes. The cost of using another instance may outweigh the QoS or performance gains. The price-performance ratio may not be optimal.

Prior art US 2014/0 289 412 A1 describes a device, method, and non-transitory computer readable medium for allocating one or more resources in a composite cloud environment. This technology involves configuring organization and service level quota values, describing service composition, service unit, service level agreement, defining allocation model and resource allocation optimization algorithm. Based on these predefined rules the infrastructure, software and manual resources are assigned, future allocation is forecasted and resources are allocated to complete the service requests received from the users.

Prior art U.S. Pat. No. 8,606,667 B2 describes systems and methods for managing a software subscription between an independent software vendor (ISV) and a cloud network provider. The software subscription can be a Software as a Service (SaaS) agreement whereby an amount of resources of the cloud network to be operated by end users can be specified. A resource tracking module associated with the cloud network can track the actual amount of resources operated by the end users in executing applications associated with the ISV. The resource tracking module can compare the actual amount to the amount specified in the SaaS, and adjust the resources of the cloud network accordingly. The SaaS can be updated based on the adjustment.

### SUMMARY

In one aspect, the invention provides for a computer-implemented method of organizing utilization of a plurality of resources in a computing environment, the computing environment being logically partitioned in layers, the method comprising executing, by a computer system being operatively coupled to the computing environment and being configured for implementing a first one of the layers, an organization routine comprising: identifying a plurality of consumers of the resources on a second layer subsequent to the first layer; for each of the resources: obtaining from a resource model a prediction of an available quota of the resource based on a configuration of the consumers; logically subdividing the available quota into chunks; executing an allocation routine comprising, for each of the consumers: obtaining a correlation matrix of utilization rates of each resource measured for the consumer; generating a resource package specific to the consumer, the generation of the resource package comprising selecting, based on the correlation matrix, a number of the chunks obtained for each resource, and adding the selected chunks to the resource package; and allocating the resource package to the consumer.

As will be explained below in further detail, the method may provide for a more realistic estimate of available quotas, and may account more precisely for interdependencies in the utilization of different resources. Therefore, the difficulties of organizing utilization in a computing environment described above may be less likely to occur in a computing environment implementing said method, and reliability of resource distribution within the computing environment may be improved.

In an example, the method further comprises initializing the resource model based on responses of the respective resource to variations of the configuration. As will be explained below in further detail, this may yield a more realistic estimate of an available quota of the resource.

In an example, the allocation routine further comprises setting a resource from the plurality of resources as a primary resource, and defining a packaging order by sorting the consumers by an expected consumption rate being expected for the primary resource by the respective consumer, the generation of the resource package for each of the consumers being performed in the packaging order with the selection of a number of the chunks obtained for each resource comprising for the respective consumer: selecting a number of the chunks obtained for the primary resource based on the expected consumption rate for the consumer, and selecting a number of the chunks obtained for another resource based on the correlation table and the expected consumption rate for the consumer. As will be explained below in further detail, this may facilitate a performance maximization for a specified resource.

In an example, the organization routine further comprises monitoring a performance indicator of the plurality of consumers, the subdivision being configured for finding a maximum of the performance indicator by applying a predefined variation of a typical size of the chunks compared to a typical size of the chunks applied during a previous repetition of the organization routine. As will be explained below in further detail, this may facilitate achieving a specified performance goal for the computing environment.

In an example, the allocation routine further comprises storing a history entry comprising data being selected from the group consisting of the utilization rates, and the correlation matrix, the organization routine further comprising receiving a history dataset comprising a history entry stored by a previous execution of the allocation routine, the generation of the resource package being further based on the history dataset. As will be explained below in further detail, this may increase a computational efficiency related to determining the optimal resource budget for a given consumer.

In another aspect, the invention provides for a computer program product comprising a computer readable storage medium having program instructions embodied therewith, the program instructions being executable by a computer system operatively coupled to a computing environment, the computing environment being logically partitioned in layers, the computer system being configured for implementing a first one of the layers, wherein execution of the program instructions on the first layer causes the computer system to perform a method of organizing utilization of a plurality of resources in the computing environment, the method comprising executing an organization routine comprising: identifying a plurality of consumers of the resources on a second layer subsequent to the first layer; for each of the resources: obtaining from a resource model a prediction of an available quota of the resource based on a configuration of the consumers; logically subdividing the available quota into chunks; executing an allocation routine comprising, for each of the consumers: obtaining a correlation matrix of utilization rates of each resource measured for the consumer; generating a resource package specific to the consumer, the generation of the resource package comprising selecting, based on the correlation matrix, a number of the chunks obtained for each resource, and adding the selected chunks to the resource package; and allocating the resource package to the consumer.

In another aspect, the invention provides for a computer system comprising a processor and a memory operatively coupled to the processor, the computer system being operatively coupled to a computing environment, the computing environment being logically partitioned in layers, the computer system being configured for implementing a first one of the layers, the memory storing program instructions which, when executed by the processor on the first layer, cause the computer system to perform a method of organizing utilization of a plurality of resources in the computing environment, the method comprising executing an organization routine comprising: identifying a plurality of consumers of the resources on a second layer subsequent to the first layer; for each of the resources: obtaining from a resource model a prediction of an available quota of the resource based on a configuration of the consumers; logically subdividing the available quota into chunks; executing an allocation routine comprising, for each of the consumers: obtaining a correlation matrix of utilization rates of each resource measured for the consumer; generating a resource package specific to the consumer, the generation of the resource package comprising selecting, based on the correlation matrix, a number of the chunks obtained for each resource, and adding the selected chunks to the resource package; and allocating the resource package to the consumer.

Embodiments of the invention are given in the dependent claims. Embodiments of the present invention can be freely combined with each other if they are not mutually exclusive.

### BRIEF DESCRIPTION OF THE DRAWINGS

In the following, embodiments of the invention are explained in greater detail, by way of example only, making reference to the drawings in which:

FIG. 1 is a block diagram depicting components of computing devices in a network context;

FIG. 2 is a block diagram illustrating layers of a computing environment;

FIG. 3 is a block diagram depicting modules involved in organizing utilization of a plurality of resources in a computing environment;

FIG. 4 is a block diagram illustrating a time sequence of resource model operations in the course of organizing utilization of a plurality of resources in a computing environment;

FIG. 5 depicts a table containing a timeline of utilization rates measured for different resources;

FIG. 6 depicts a correlation matrix of utilization rates;

FIG. 7 depicts a resource table containing information about chunks obtained for different resources;

FIG. 8 is a diagram illustrating a generation of resource packages; and

FIG. 9 depicts a code sample defining contents of a resource package.

### DETAILED DESCRIPTION

Allocating multiple resources to multiple consumers across multiple branches is a complex task due to consumer-specific patterns of resource utilization, including consumer-specific interdependencies of the resources; due to possible strong dependencies of the available amount of a resource on the configuration of the consumer; and due to performance requirements and limitations that are supposed to be met by an infrastructure operator or provider. Similarly, allocating resources hierarchically to different layers of a computing environment may be challenging due to changing software, and thereby, changing resource consumption patterns at each layer. Therefore, improvements in reliability of resource distribution in a computing environment are desirable.

For the purposes of the present disclosure, a computing environment may be considered as a computing network connecting multiple computer systems with each other, and where a plurality of resources is available to the computer systems by virtue of the configuration of the computing environment, or becomes available by virtue of operating the computer systems in the network. Without limitation, examples of a computing environment are a cloud infrastructure, and a data center operating as a standalone facility or within a network of data centers including, but not limited to, a cloud infrastructure. The concepts provided here may be extendable to hosting services like OCP, Kubernetes, or any unit running microservices in a straightforward manner. It may be possible as well to attach the proposed approach to metering and pricing models of services such as virtual applications that are consumers in the sense of the present disclosure. For example, virtual applications may be billed according to the contents of resource packages they have consumed.

Within the present disclosure, a resource may be defined as a countable technical item that is accessible for utilization within the computer systems of the computing environment and that, when utilized, causes or increases a performance of the respective hardware or software entity (the consumer) accessing the resource. For example, the number of input/output operations per second (IOPS) of a storage disk may be a resource, network bandwidth may be another resource. The proposed solution does not limit itself to the nominal description of a computing resource, for example, processing capacity (also referred to herein as “CPU”), disk bandwidth, network bandwidth etc. Rather, there may be other resources available in addition that can be distributed among the consumers. For example, respective amounts of utilization of a crypto card, of hardware accelerators (e.g., an IBM Artificial Intelligence Unit (AIU), or an IBM Integrated Accelerator for zEnterprise Data Compression (zEDC)), or of a remote resource (e.g., on another LPAR). More examples of possible resources whose utilization may be organized in a computing environment is given further below.

Allocating resources is often not just a problem of assigning disk, network and processing quotas to virtual servers and other consumers. The resource allocation problem may be extrapolated to incorporate multiple layers of a computing environment. For example, a data center may consist of many platforms, all of which may be asking for resources that are available at the data center layer. For example, there may be a large cluster storage available, and the storage bandwidth should be allocated to multiple mainframes of different platforms (e.g., IBM z15, IBM z14 and x86) within the data center.

Similarly, each platform that is allocated a budget of a resource may need to distribute it among the hosts. In the example, a z15 mainframe may need to allocate the quota of its cluster storage bandwidth among the various logical partitions (LPARs) running on the z15 mainframe. Moreover, these LPARs then may need to allocate the quota among respective sets of virtual servers hosted on the LPARs. In turn, the virtual servers may further distribute their respective quota to, e.g., a set of Kubernetes pods, etc.

The present disclosure applies a model assuming that an arbitrary computing environment where multiple resources are utilized by multiple consumers can be logically partitioned in a plurality of availability layers. According to the model, an individual layer n may distribute a quota of resources among a set of consumers on a subsequent layer n+1, n+2, or higher, and an individual layer n may get a resource budget from a preceding layer n−1, n−2, or lower. This may include that a given layer may contain multiple hardware devices and/or multiple software processes getting allocated quota of available resources by a device or process operating on a preceding layer.

In particular, it may be possible that a single hardware device may implement multiple layers at the same time, as may be the case for a mainframe computer distributing a resource quota among a plurality of logical partitions (LPARs) being defined on the mainframe, where each LPAR in turn distributes its allocated portion among a plurality of virtual servers running on the respective LPAR, each virtual server distributes its quota among a plurality of applications running on the respective virtual server, etc. On the other hand, the layer model may also apply at lower layers such as a data center layer unit distributing resources among a plurality of mainframes, or an availability zone unit distributing resources among a plurality of data centers.

The units and/or processes receiving quota from an allocating unit or process on a lower layer are referred to herein as the consumers with respect to the allocating unit or process. A computer system may be denoted as implementing a particular availability layer (e.g., the first layer) if it executes a process that receives or determines an availability of a resource quota and distributes it among a plurality of consumers (processes or devices running such processes) that, by virtue of said distribution, may be assigned to a subsequent availability layer (e.g., the second layer). The method disclosed herein may be understood as being carried out by a computer system implementing a first availability layer of a computing environment, and in particular, by a process being executed on the first availability layer. A process implementing the method, as well as a computer system executing such process, may be referred to herein as an allocator.

The present disclosure gives multiple examples illustrating details of the method described herein. A repeated or primary example refers to an allocator process running on a host-layer unit (e.g., an LPAR of a mainframe) and allocating resource quota to a plurality of virtual servers running on the host-layer unit. It is understood that the specific choice of a host layer as the first layer and of virtual servers as the consumers is not limiting to the scope of the present disclosure. Rather, as disclosed herein as well, the approach may be implementable at any availability layer of a computing environment.

The method comprises executing an organization routine. The term “organization routine” may be understood as referring to a portion of the method that may be repeated to achieve a more adaptable, iterative organization of resource utilization in the computing environment. Steps and features not included in the organization routine do not necessarily have to be included in repeated iterations of resource utilization organization, while, on the other hand, they are not necessarily excluded from such repeated iterations. Without limitations, the organization routine can run on the same layer where the resources are distributed, on another layer of the computing environment, or a separate computer.

The organization routine comprises the step of identifying a plurality of consumers of the resources on a second layer subsequent to the first layer. Without limitation, the identification may make use of known or future system identification methods that may include retrieving or receiving a list of devices or processes on a second layer defined by a dependency relation to the first layer in terms of the direction of distribution of resource quotas, and/or an event-based approach that includes a receipt of a notification signal each time a new potential consumer on such second layer becomes available. The identification may be performed once, e.g., at the beginning of the organization routine, or may be repeated so as to keep the knowledge of potential consumers up to date by monitoring.

Further, the organization routine makes use of a resource model that allows for carrying out the step of obtaining (e.g., receiving, determining, or generating), for each of the resources, a prediction of an available quota of the resource based on a configuration of the consumers. A resource model that is able to predict an available quota of a resource based on a configuration of a consumer utilizing the resource may take into account that there are resources whose availability depends (strongly in cases) on the configuration of a consumer that utilizes the resource. The resource model may, for instance, be executed as a process running separate from the allocator, or may likewise be an integrated function of the allocator process. The resource model process may receive or retrieve current configuration parameters of the consumers that may have an influence on the available amount of one, some, or all of the resources.

The resource model may be structured in various ways, having, e.g. separate predictor functions for some of the different resources, or a common predictor function for some of the resources, or a combination thereof. There may also be many possibilities of implementing such predictor functions, e.g., by an artificial intelligence (AI) approach using a trained machine-learning (ML) model, by arithmetic or otherwise mathematical functions, by a lookup table or database of resource responses to known sets of configuration parameters, or a combination thereof, possibly in combination with interpolation, extrapolation and/or approximation functions. Since each entity on the first layer (e.g., each LPAR hosting multiple virtual applications) may have its own resource model process, each consumer on the second layer (e.g., each virtualized application) may obtain an appropriate share of resources.

The resource model may return an estimate of the available amount of the affected resources as a function of the configuration parameters. In order to do so, the resource model may incorporate knowledge of how the available amount of a resource typically responds to different values of the configuration parameters. This knowledge may be obtained in various ways, e.g., by experimentally observing, before or after startup of the consumers, responses of the resources to preset configurations, by implementing a theoretical model, or by reproducing human knowledge obtained by experience.

The following section illustrates setup and operation of a resource model that is implemented by an ML model running on the host layer (first layer, LPAR level) of a data center in the course of distributing resource quota to a plurality of virtual applications (consumers, second layer) running on the host. In the example, the machine learning component is responsible to get the estimate of the total amount of a disk bandwidth available for the virtual applications. It may be straightforward to map the principles of this example to any other kind of resource model and any other choice of resource.

In the example, in the initial phase, a script may generate a random permutation of the block sizes (denoted by blksize) and queue depths (denoted by qdepth) to simulate a number of consumers having this random configuration. At the same time, using these current values of blksize and qdepth, the machine learning algorithm may try to get the maximum throughput of the disk, denoted max_disk_bw, by exerting the disk to a full I/O load. By testing many permutations of blksize, qdepth and obtaining the resulting max_disk_bw, the training effect of the ML model may be an approximation of the coefficients a, b, . . . , p, . . . and z in the formula:

max_disk_bw=m*a*blksize1+n*b*blksize2+ . . . +p*qdepth1+ . . . +z,

where m, n is the number of consumers having block size blksize1 and blksize2, respectively. This means that if provided with the information that the hosting system is using a certain blksize1, blksize2, . . . and qdepth1, the maximum available disk bandwidth max_disk_bw may be determined. It shall be noted that the model shown above can be different for different resources. Similarly, it does not need to be linear.

When the example system goes live, i.e., when the consuming virtual applications are started, the machine learning algorithm may determine the maximum bandwidth and the IOPS available for the disk by analyzing the configurations used by the virtual applications. By snooping information like the block sizes that a virtual application may use (blksize1, blksize2, . . . ), and the depths being used by the individual I/O queues (qdepth1, qdepth2, . . . ), the machine learning algorithm may recognize a pattern and may thus determine the maximum number of the IOPS and the bandwidth that can be provided by the disk.

Still in the example, the algorithm may similarly determine a maximum number of input and output packets as well as a maximum amount of input and output bandwidths provided by the network interface. Like with the disk, the machine learning algorithm may recognize the packet sizes and therefore, provide an estimate of the maximum resources provided by the network interface. In addition to the disk, network and CPU, there may be other resources in the hosting system that can be distributed among the virtual applications. For example, capacity provided by a crypto card, by hardware accelerators (e.g., AIU, zEDC), and/or by a remote resource (e.g., available on another LPAR).

The organization routine further comprises the step of obtaining (e.g., receiving, determining, or generating), for each of the consumers, a correlation matrix of utilization rates of each resource measured for the consumer. This may take into account that each consumer may show a specific pattern of behavior in the combined utilization of different resources, i.e., the interdependencies of the resources can differ from consumer to consumer. These interdependencies may be captured by pair-wise correlation measures between the resources.

More specifically, the utilization rate of each resource may be considered as a variable quantity, where the correlation of two of these quantities may measure a degree of change in one quantity in response to a unit of change in the other quantity. In order to obtain reliable correlation values, multiple measurements of utilization rates may be necessary for each resource. As the correlation matrix can be assumed to be specific to each consumer, there may be a separate correlation generator process running for each consumer from which the resource allocator receives the current correlation values. However, this function may likewise be integrated with the allocator by keeping or retrieving a separate dataset of utilization measurements for each consumer, and generating the correlation matrix centrally for each consumer.

The correlation matrix may contain objective information about how a change in utilization of a specific resource by a specific consumer may affect the utilization of other resources by this consumer. The following section illustrates this by an example where, again, the allocator operates on LPAR level as the first layer to distribute resource quota to a plurality of virtual applications (consumers, second layer) running on the hosts.

In the example, the correlation generator component may determine correlations among the resources utilized by the individual virtualized applications. It may show the relationship among the different resources utilized by a particular virtual application. Each virtual application may have assigned its own correlation generator. The correlation generator may work in the live phase, i.e., after startup of the consumers. It may use state-of-the-art regression and system identification methods to determine the relationship between usage of different resources.

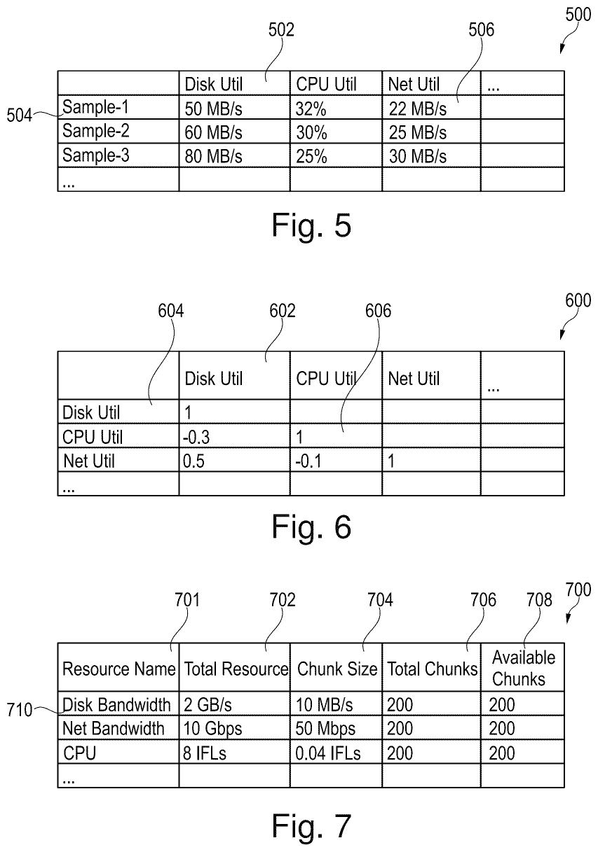

To determine correlation measures among the resources that are used by a particular virtual application, the exemplary correlation generator may sample the resource utilization data from the virtual application. This snooping may occur periodically (e.g., at a predefined sampling period such as once per second). Using this data, the exemplary correlation generator may create a sample table such as that shown in FIG. 5 and discussed further below. The resource specific utilization data in this table may be used by the exemplary correlation generator to determine correlations among the different resources for the given consumer. Using the sample table, the exemplary correlation generator may create a correlation matrix such as that shown in FIG. 6 and discussed further below.

The organization routine further comprises the step of logically subdividing (“chunking”) the available quota into chunks for each resource. The number and the size of the chunks to be obtained may be considered free parameters of this step. In particular, the size of the chunks may be constant, but does not have to be constant necessarily. The number of chunks may be specific to each resource, which, however, is also not a requirement. Multiple ways of governing the chunking process may be possible, including, without limitation, an administrator policy or an automatic function for determining the chunks size or number as a function of system parameters such as an expected or given number of consumers, or other properties of software and/or hardware related to the consumers. Chunking the available quota may facilitate quota allocation with a slight overprovisioning to accommodate utilization variations of the consumers.

The following section illustrates the chunking process with a non-limiting example of chunking maximum quotas of disk bandwidth and network bandwidth that are predicted to be available on host (LPAR) level for consumption by a plurality of virtual applications. In the example, the resource model provides a set of available resource quota of the hosting system, given the virtual application configuration. Using these predictions, the resource allocator chunks the available quota for further use.

In the example, the resource model indicates that the maximum available disk bandwidth is 2 GiB/s for the given resource utilization pattern defined by the configuration of the virtual applications. In the example, the chunking of this quota has been configured to be performed by constant size, with each chunk equal to 10 MiB/s. So, in total, the example system may provide up to 2*1000/10=200 chunks of disk bandwidth, each of 10 MiB/s. Similarly, if the maximum network bandwidth estimated by the resource model is 15 Gbps, the chunking of this resource may also be performed by constant size with each chunk equal to 50 Mbps. Therefore, there may be a total of 15*1000/50=300 chunks of network bandwidth, each of 50 Mbps. At the end of the chunking process, the example allocator may generate a resource table such as that shown in FIG. 7 and discussed further below, that keeps track of the chunking parameters and the currently available number of chunks for each resource.

The method further comprises the step of generating a resource package specific to the consumer, the generation of the resource package comprising selecting, based on the correlation matrix, a number of the chunks obtained for each resource, and adding the selected chunks to the resource package. This step may be influenced both by the estimates of available resource quotas provided by the resource model, and by the correlation matrix obtained from the measured utilization rates.

One can think of various possible approaches to joining the resource chunks based upon the correlation values. In any case, it may be desirable that the combination of selected chunks in a resource package, after completion of its generation (a “completed resource package” in the following), reflects the correlation measures for the pairs of resources obtained specifically for the respective consumer. For a pair of resources having a positive correlation measure within the correlation matrix, this may include that the number of chunks selected for one of the resources is increased/decreased if the number of chunks selected for the other one of the resources is increased/decreased. On the other hand, for a pair of resources having a negative correlation measure within the correlation matrix, this may include that the number of chunks selected for one of the resources is decreased/increased if the number of chunks selected for the other one of the resources is increased/decreased. Furthermore, a correlation measure may be indicative of a degree or strength of positive or negative correlation. In this case, for a pair of resources having a correlation measure within the correlation matrix that is indicative of fully correlated resource utilizations, this may include that the number of chunks selected for one of the resources is increased/decreased in the same manner as the number of chunks selected for the other one of the resources is increased/decreased. On the other hand, for a pair of resources having a correlation measure within the correlation matrix that is indicative of incompletely correlated resource utilizations, this may include that the number of chunks selected for one of the resources is increased/decreased in a reduced manner as the number of chunks selected for the other one of the resources is increased/decreased.

However, it may be worthwhile to note that the previous considerations may be taken into account for only one pair of resources, but a completed resource package may contain contributions of chunks from multiple pairs of resources reflected by different correlation measures. For instance, if a resource B is weakly correlated to a resource A, a package being generated may get added a number of chunks from resource A that add up to a larger portion of the estimated available quota of resource A than the portion of chunks the package receives for resource B adds up in relation to the estimated available quota of resource B. However, there may be another resource C that is weakly correlated to resource A and strongly correlated to resource B. In this case, the package being generated may get added a number of chunks from resource B that add up to a larger portion of the estimated available quota of resource B than the portion of chunks the package received for resource B when previously considering the correlation between resource A and resource B.

An example of package generation that may take the consideration above into account is given further below.

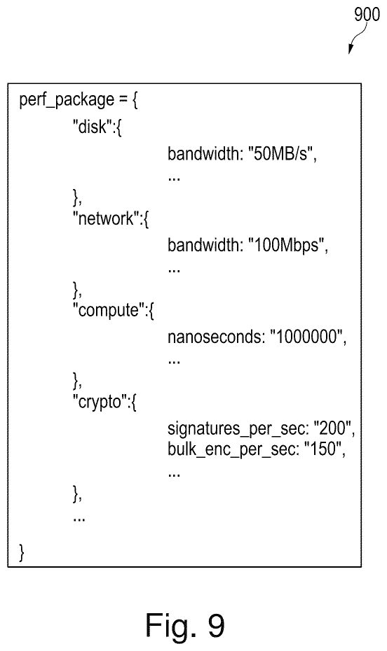

The method further comprises the step of allocating the resource package to the consumer. Without limitation, the resource package may be defined using text declarations such as those shown in FIG. 9 and discussed further below. This package may then be provided to an entity managing the consumers, such as a cloud manager, that reads the package and then sets the limitations for some or all of the resources, such as disk, network and computing bandwidths, on individual consumers. In a non-limiting example, the consumers may be virtual applications using a KVM hypervisor. In such scenario, a cloud manager may tune the xml configuration files of the KVM guests and add these resources as limits for the KVM guests. In the example, a QEMU emulator may then ensure that these limits are respected by the KVM guests. An end user of a consumer being subject to such automatic configuration changes may optionally be notified about newly allocated quotas. An exemplary framework for this approach may be a software-as-a-service model (e.g., database as a service (DBaaS)) where the hosting environment allocates resource packages to a set of virtual machines (VMs), and the VMs run software on behalf of an end user. In this example, the performance of the software may get improved without any end-customer intervention. Another scenario may include a distribution of resources at a datacenter-wide layer where the end-customer has no control.

Alternatively or additionally, some or all of the resource quota specified by the performance packages may be proposed to end users of the consumers, and these changes may be accepted (e.g., bought) by the end users. Multiple approaches appear possible for the case that a resource package is suggested to be allocated to consumers of end customers, but the end customer does not buy it. One example may include that in a future repetition of the organization routine the customer is not included in the resource distribution and the original resources with this end-customer remain without any package proposal for a predefined amount of time before proposing a new resource package another time. Another example may include to still propose a new package to the customer during each repetition and if the end user still does not decide to buy it, then the original resources remain. Another example may include to ask the end-customer before starting a consumer (e.g., a service) whether the end-customer wants a dynamic performance environment.

Steps of the method that are specific to a resource consumer, such as the obtainment of the correlation matrix and the generation and allocation of the resource package, may be summarized as an allocation routine.

Embodiments of the invention may have the advantage that the generation of the resource package for each consumer is influenced by estimates of available resource quotas that are based on a configuration of the consumers, and by the consumer-specific resource usage pattern reflected by the correlations of resource utilization as well. A resource model that is able to predict an available quota of a resource based on a configuration of a consumer utilizing the resource may take into account that there are resources whose availability depends (strongly in cases) on the configuration of a consumer that utilizes the resource. Using such resource model, it may become unnecessary to make assumptions on the actually available amount of a resource with no regard to effects that a consumer's configuration might have thereon. Furthermore, a correlation generator configured for assessing the specific resource utilization behavior of a process consuming a resource may introduce even more evidence into the resource allocation process. In this manner, the estimate of the available resource quota may be closer to an actually available amount of each resource, and it may be ensured that each consumer gets allocated an appropriate amount of each available resource that may be closer to a specific combination of resource quota the consumer may actually require in the future. Overall, a more reliable and efficient resource allocation may be achieved in the sense that miscalculations such as excessive overprovisioning or underprovisioning of resources may become less likely, and that a more stable degree of QoS fulfilment may become possible.

In an example, the method further comprises initializing the resource model based on responses of the respective resource to variations of the configuration. This may have the advantage that the resource model gets an empirical base for its function that does not rely on theoretical rules or assumptions. A prediction of an available quota of a resource made by an empirically-based resource model may provide a closer reproduction of the dependence of an actually available resource quota on the configuration of consumers while the resource is utilized, and may thus have an improved predictive accuracy and reliability. For instance, before the startup of the consumers, the resource model may test different configurations that might be used by the consumers. Based upon these configurations, it may obtain information about how to estimate the available resources given the configuration. These initial test configurations may be self-generated by using, e.g., a random permutation of configurations within predefined bounds, or a human may provide them, e.g., as a standard set of test configurations. It may also be possible to obtain the resource model after startup of the consumers, for example, at times when an aggregated utilization of the resources by the plurality of consumers is comparable low.

In an example, the resource model is a machine learning model, the initialization of the resource model comprising training the machine learning model using a training dataset incorporating the variations of the configuration and the corresponding responses of the resource. A machine-learning driven resource model may be less prone to systematic error caused by making model assumptions about influences that particular configuration parameters may have on the available amount of a resource, and about whether particular correlations of configuration parameters may be negligible for the prediction or not. It may be able to reproduce more complex connections between a plurality of configuration parameters and the availability of a plurality of resources by learning instead of finding an arithmetic or numeric approximation. Moreover, a machine-learning resource model may be obtainable with a lower (or no) degree of user attention. The training dataset may be obtained in an automated manner, e.g., by tracking the tested configurations and the available quotas received in response thereto. Many different kinds of machine-learning models may be appropriate choices to implement a resource model.

In an example, the configuration comprises a numeric configuration parameter of the consumers, the resource model expressing the available quota as a mathematical function of the configuration parameter, the initialization of the resource model comprising determining a coefficient of the configuration parameter in the mathematical function. This may provide a greater simplicity of defining the resource model and/or of initializing the resource model. For instance, the initialization of the resource model may be achieved with a lower requirement of computing resources than may be needed for training a machine learning model, and it may be sufficient to program the mathematical function as a straightforward formula in a programming language of choice. However, the resource model's expression of the available quota as a mathematical function does not necessarily exclude that the resource model may be implemented as an ML model, as certain ML models may be configured to deliver the coefficients of the mathematical function as an output. A coefficient may be considered any numeric parameter of the mathematical function that regulates the extent to which a change of a configuration parameter changes the value of the mathematical function. For instance, an exemplary mathematical function may comprise a term that is a product of a particular configuration parameter and its corresponding coefficient. Without limitation, an exemplary mathematical function may be a sum over products of a coefficient and a power of its corresponding configuration parameter.

In an example, the initialization of the resource model is completed before a startup of the consumers, the organization routine further comprising, after the startup of the consumers, obtaining a recent value of the available quota for one of the resources, and adjusting the resource model based on the recent value of the available quota and the configuration of the consumers. If there is an initial setup phase during which no consumer is operating, an initialization of the resource model during the setup phase may have no influence on the later operation of the consumers. However, the response of a resource to a particular configuration of the consumers during the setup phase may be different from the response of the same resource after the startup of the consumers (also referred to herein as “the live phase”). Interactions among the consuming processes or devices, interactions between the consuming processes or devices and surrounding hardware, devices and/or processes running within the computing environment, and/or additional load such as overhead loads causing resource utilization in addition to the net resource utilization caused by the operation of the consumers taken alone may be possible reasons for this differing behavior. Thus, a readjustment of the resource model during the live phase may improve the predictive accuracy of the resource model, i.e., the closeness of the predicted available resource quotas to the actually available resource quotas, even further.

In an example, the method further comprises receiving a policy, the organization routine being adapted for applying the policy, the policy comprising a requirement selected from the group consisting of: a number of the chunks to be provided by the subdivision; a size of the chunks to be provided by the subdivision; a priority of a consumer for the selection of a number of the chunks; a priority of a resource for the selection of a number of the chunks; and a nominal number of repetitions of measurements of the utilization rates to be completed before triggering a further execution of the organization routine. A policy may allow a user such as an administrator of the computing environment to tailor the performance of the method toward a particular desired direction. The policy may be provided to the allocator, e.g., as one or more dedicated specification files or as a subset of conditions and/or instructions within a larger file or database of conditions and/or instructions governing the operation of the first layer, the second layer and/or the computing environment or a portion of the computing environment where the allocator is operating. If the method is concurrently applied on multiple layers of the computing environment, there may be different policies for each layer of the computing environment. As can be seen in the following, technical effects of the policy may depend on the requirements the policy poses on the performance of the method.

The policy may comprise a resource budgeting policy. For instance, predefining the number or size of the chunks to be obtained by the subdivision of the predicted available quota may have an effect on the amount of resource that is overprovisioned for a particular consumer, where some extent of overprovisioning is assumed to be desirable to accommodate for inevitable variations of resource utilization during normal operation of the consumer. The resource budgeting policy may determine how the allocator chunks and then packages the resources for each individual consumer. In an example, the resource budgeting policy can be written by an administrator of a cloud provider, taking into account information from the infrastructure as well as the business management.

The resource budgeting policy may define how a resource is chunked. Once the resource chunking for each resource of the first is defined, the number of chunks that should be distributed among the consumers may be determined. This information may also be used by the allocator to provision the budgets to the virtual applications. Moreover, it may be possible to use the policy to set the size of a chunk to observe a performance delta in a particular consumer to which the chunk is provided. Likewise, the resource budgeting policy may enable to tailor the chunks to each resource. For example, a disk resource may have more chunks than a CPU resource. A resource budgeting policy may also define a relation between an expected or predefined number of consumers and the size and/or number of chunks to be obtained depending on that number. If the number of virtual applications is known, the right policy can be written to determine how many chunks of the resource are needed. If, for instance, there is an exceptionally large number of consumers, it may be worthwhile to define smaller chunks to ensure that the number of chunks is large (e.g., by at least a predefined factor greater than one) against the number of virtual applications.

A priority of a consumer for the selection of a number of the chunks may be realized by generating the resource package for the priority consumer before generating the resource packages for the non-priority consumers. Thus, a consumer priority may ensure that the priority consumer obtains an optimum amount and combination of all resources, while the non-priority consumers may have a higher probability that one or more of the packaged resource quotas are not optimal for all utilization situations that may reasonably occur during operation of the respective non-priority consumer. An administrator may define a particular consumer as a priority consumer to ensure a high-performance operation for business critical consumers or consumers operated by premium customers. If, for instance, a consumer is handling a critical component of a certain project, it may be conducive for the success of the project to carry out resource allocation to this consumer first.

A priority of a resource for the selection of a number of the chunks may be realized by selecting the number of chunks for the non-priority resources dependent of the number of chunks for the priority resource, e.g., according to the ratio of the non-priority resource quotas to the priority resource quota corresponding to the respective correlation measures in the correlation table. Thus, it may be ensured that a consumer receives an optimal quota of the priority resource with a high probability, while receiving an optimum quota of the non-priority resources may be less likely. An administrator may define a particular resource as a priority resource if, e.g., a high total utilization rate is desirable to achieve a certain business goal or QoS requirement. It may also be possible to define priority resources specific to different consumers. For instance, one virtual application is CPU critical, while another virtual application relies on a guaranteed minimum bandwidth. In this example, processing capacity may be set as a primary resource for the first application and network bandwidth may be set as a primary resource for the second application. A hybrid effect appears possible by defining a priority resource for a priority consumer.

A nominal number of repetitions of measurements of the utilization rates to be completed before triggering a further execution of the organization routine may be useful to ensure that the correlation table of a consumer is based on a sufficiently large data basis, and/or that changes of quota allocations do not occur too frequently, which may be detrimental to a predictable operation of the consumers, or too rarely, which may reduce flexibility of the consumers for adapting to changes in the plurality of resources or changes within the computing environment affecting the available amounts of the resources.

In an example, the allocation routine further comprises, for each of the consumers, obtaining a requirement table based on the utilization rates measured for the consumer, the requirement table comprising a typical utilization rate of each resource assumed by the consumer, the generation of the resource package being further based on the requirement table. This may facilitate orienting the packaging closer to the actual resource requirements of a particular consumer. For instance, the packaging routine may implement a consistency check that evaluates the completed resource package and may apply corrections to the packaged quota if a deviation exceeding a predefined specification is detected. Another possible way of incorporating a resource table into the packaging process may be to take the resource amounts in the resource table as start values, relative to which resource quotas of other resources may be obtained using the correlation table. A typical utilization rate may be any statistically meaningful representative number (e.g., an average such as the arithmetic average, a median, etc.) of the utilization rate a consumer assumes for a particular resource over time.

In an example, the organization routine is repeated according to a predefined schedule. A repetition of the organization routine may include newly identifying the plurality of consumers on the second layer, whereby changes in the plurality of consumers such as additions or removals of consumers may be included in the next generation of resource packages; obtaining from the resource model an updated prediction of an available quota of the resources based on the configuration of the consumers, whereby changes in the configuration may be taken into account during the next generation of resource packages; newly obtaining the correlation matrix for each of the consumers, whereby changes in the consumption behavior of the consumers may be accommodated; and newly generating and allocating a resource package for each of the consumers, thereby adapting each consumer's resource quota to the aforementioned possible changes. Overall, a repetition of the organization routine may enable an adaptation of the resource allocation to changing parameters of the computing environment.

The predefined schedule may include regular and/or irregular repetitions of the organization routine, depending on characteristics of the computing environment such as the frequency at which changes occur that might affect the performance of the consumers having allocated their respective current resource quota. The following application example illustrates a schedule where a fixed repetition interval called “epoch” is defined in relation to a fixed sampling interval at which the utilization rates of the resources by the consumers are measured. Although the sampling interval and the epoch are fixed in the application example, it is understood that the schedule may further contain exceptions such as omissions, rescheduling and/or additional repetitions of the organization routine and/or of the measurement of the utilization rates.

In the application example, the measurement of the resource utilization rates may be repeated at a fixed sampling interval. As a general principle that is not specific to this application example, the sampling interval may differ between the respective consumers, and/or may differ between the respective resources as may be appropriate. In the application example, the sampling interval may be fixed for all consumers and all resources to an identical value, e.g., using a policy as introduced above. The sampling interval may be set by an administrator or another expert user of the computing system. If a requirement table as discussed above is generated, the typical utilization rates stored by the requirement table may be updated, e.g., at the frequency corresponding to the sampling interval, or at a lower frequency (e.g., every 10 sampling intervals) that may be between the sampling interval and the epoch, for instance. In the application example, the administrator may set the sampling interval to 10 seconds. Another exemplary sampling policy may be to use a dynamic sampling interval. For instance, a dynamic sampling interval may be set to take a new measurement of the resource utilization rate when the CPU load is not above a predefined threshold value (e.g., not larger than 50%) and the time since the previous measurement is at least a predefined threshold value (e.g., at least 10 seconds). Another dynamic sampling policy may include taking a new measurement of a particular resource utilization rate if the increase in the CPU load caused by the measurement is not larger than a predefined threshold value (e.g., an increase in CPU load of not more than 1%).

In the application example, the organization routine may be repeated at a frequency defined by an epoch time interval. The epoch time interval may be larger than the sampling interval and may include an integer multiple (e.g., 10 times, 30 times, 100 times, . . . ) of the sampling interval. The epoch time may be a fixed value and/or may be defined as a fixed multiple of the sampling interval. The epoch time interval may be set by an administrator or another expert user of the computing system. Like the sampling interval, the epoch time interval may be set using a policy as discussed herein. In the application example, the sampling interval is set to 10 seconds and the epoch time interval is set to 5 minutes, which corresponds to an integer multiple of 30. However, it may also be possible to set a dynamic epoch policy without fixed intervals. For instance, a repetition of the organization routine may be triggered if there is workload variation exceeding a predefined threshold. In the application example, a repetition of the organization routine is triggered if the workload of the consumers varies by more than 5%. This may be combined with an epoch time interval, such as triggering the repetition of the organization routine if the workload varies by at least 10% after at least 10 minutes. Moreover, the duration of an epoch does not necessarily have to be constant. Another example could include gradually increasing the epoch time interval when it is determined that workload variations reach an equilibrium (e.g., the workload stays within predefined boundaries around an average value), and vice versa, gradually decreasing the epoch time interval if the observed workload variations exceed these boundaries.

In an example, a repetition of the organization routine is triggered earlier than according to the in response to detecting fulfilment of a predefined condition being selected from the group consisting of a peak utilization of one of the resources, and an addition of a new consumer to the plurality of consumers. Repeating the organization routine in response to detecting a peak utilization of one (or more) of the resources may result in an allocation of new resource packages to the consumers that may provide a better support for the current workload situation and may thus reduce the resource utilization(s) causing the peak utilization condition by optimization. In this way, times of overly high resource utilization may be shortened. A peak utilization may be detected, e.g., by monitoring the measured resource utilization rates of the consumers. A peak utilization may be detected if, for instance, the utilization rate of one or more of the consumers exceeds a predefined threshold value, or if the utilization rate of one or more of the consumers shows a relative increase exceeding a predefined percentage. Detecting a peak utilization based on multiple consumers may be achieved in various ways, e.g., by monitoring an aggregated (e.g., average) resource utilization rate of the consumers, or detecting exceedance of a predefined threshold utilization by at least a predefined threshold number of the consumers.

In an example, the organization routine is repeated in response to identifying an addition of a new consumer to the plurality of consumers. Repeating the organization routine in response to detecting an addition of a new consumer to the plurality of consumers (generally at once, or earlier than scheduled if a schedule is used) may ensure that the newly added consumer benefits, consumer in an equivalent manner as the previously running consumers, from the improved resource allocation disclosed herein to receive a resource package that is tailored to the needs of the newly added consumer. This may shorten the time the newly added consumer has to operate with a combination of resource quota that may be inappropriate for the specific pattern of resource utilization assumed by the newly added consumer. Moreover, the configuration of the newly added consumer may also impact the availability of the resources for the other, previously running consumers. Therefore, an early re-prediction of the available resource quota may help keeping track of the currently available amounts of the resources and may reduce the time during which the assigned quota for the previously running consumers is based on earlier assumptions that may be not valid anymore due to the effect of the newly added consumer. For a newly added consumer, it may be advantageous to trigger another early repetition of the organization routine (i.e., after a time interval that is shorter than a time interval between two subsequent repetitions of the organization routine according to the schedule) to account for the effect that newly started workloads may have a high variation of resource utilization at the beginning that approaches an equilibrium of (approximately, within boundaries) constant resource utilization after some uptime. The shortened epoch duration may then be adaptively increased to reach the nominal duration of the schedule after a few cycles.

In an example, the allocation routine further comprises generating a spare resource package, the generation of the spare resource package comprising selecting a number of the chunks obtained for each resource as spare chunks to be withheld from the allocation of the resource packages, and adding the selected spare chunks to the spare resource package, the allocation routine further comprising, in response to detecting a peak utilization of one of the resources by one of the consumers, allocating a spare chunk of the resource subject to the peak utilization to the consumer causing the peak utilization, and in response to an addition of a new consumer to the plurality of consumers, allocating a spare chunk of each resource to the new consumer. The spare resource package may contain one or more spare chunks of the resource quota of each resource. The number of spare chunks to be added to the spare resource package may be set by a policy or may be based on known or assumed boundaries of variation of resource utilization that is typically assumed by a given or expected number of consumers. Another possibility for generating the spare resource package may be to add an assumed dummy consumer to the plurality of consumers and include the dummy consumer in package generation process based on a predefined dummy configuration of the dummy consumer and predefined dummy resource utilization data assigned to the dummy consumer.

If a given consumer fulfils a peak utilization condition for a given resource, allocating a spare chunk of the given resource to the given consumer may provide an additional portion of the resource to the consumer, and may thus improve its performance. A peak utilization may be detected, e.g., by monitoring the measured resource utilization rates of the consumers. A peak utilization may be detected if, for instance, the utilization rate of one or more of the consumers exceeds a predefined threshold value, or if the utilization rate of one or more of the consumers shows a relative increase exceeding a predefined percentage. Detecting a peak utilization based on multiple consumers may be achieved in various ways, e.g., by monitoring an aggregated (e.g., average) resource utilization rate of the consumers, or detecting exceedance of a predefined threshold utilization by at least a predefined threshold number of the consumers.

Moreover, one or more spare chunks of each resource may be allocated to a newly added consumer in order to enable execution of the newly added consumer without having to restart the organization routine. For instance, a predefined standard combination of chunks may be allocated to the newly added consumer. In another example, a known minimum quota of each resource may be allocated to the newly added consumer using the spare chunks, where the minimum quota of a resource is at least a known smallest quota of the resource that the newly added consumers requires to be able to run at all. In another example, a history dataset exists for the newly added consumer, designating a combination of resource quota that was allocated to, or utilized by, an earlier instance of the newly added consumer, and the number of spare chunks allocated to the newly added consumer is based on the resource quota designated by the history dataset. In another example, a history dataset exists for the newly added consumer, designating a correlation matrix that was determined for an earlier instance of the newly added consumer, and the number of spare chunks allocated to the newly added consumer is based on the correlation matrix designated by the history dataset. Many further ways of determining the number of spare chunks of each resource to be allocated to a newly added consumer may be possible.

In an example, the generation of the resource package is adapted for ensuring that the resource package contains at least a minimum quota of the current resource predefined for the consumer. This may ensure that the consumer for which the resource package is generated is able to run, or to continue running, and that the generation of the resource package does not result in an accidental underprovisioning of resources for that consumer. Predefined minimum quotas for a specific consumer may be available in metadata such as header data stored in memory at runtime, a package repository, a driver or other information provided by a hardware manufacturer, etc. Ensuring that the resource package contains at least the predefined minimum quota may be implemented, e.g., as a pre-packaging routine (e.g., adding the minimum quota before the selection of the number of chunks) or a post-packaging routine (e.g., when the addition of the selected chunks is finished for a current resource, adding further chunks of the current resource to the resource package until the minimum quota is fulfilled).

In an example, the allocation routine further comprises setting a resource from the plurality of resources as a primary resource, and defining a packaging order by sorting the consumers by an expected consumption rate being expected for the primary resource by the respective consumer, the generation of the resource package for each of the consumers being performed in the packaging order with the selection of a number of the chunks obtained for each resource comprising for the respective consumer: selecting a number of the chunks obtained for the primary resource based on the expected consumption rate for the consumer, and selecting a number of the chunks obtained for another resource based on the correlation table and the expected consumption rate for the consumer. This may have the effect that quotas of resources that are not set as a primary resource may be determined dependent of the resource quota that is determined for the primary resource, while dependencies that the primary resource might have with respect to non-primary resources may be neglected. In this way, a performance optimization may be achieved for the primary resource. A performance optimization may be especially beneficial for resources having stronger limitations than other available resources. The primary resource may be designated using a policy as disclosed herein or another means of configuration. For instance, an administrator may use a policy to set a resource as the primary resource that is known to be scarcest on a particular layer. It may be possible to set more than one resource as a primary resource. In this case, a separate packaging order may be determined for each primary resource, the independent selection of a respective number of chunks may be performed for each primary resource in the respective packaging order, and the number of chunks for a non-primary resources may be based on a combination of the correlation measures of the non-primary resource with respect to each primary resource. The expected consumption rates for a given consumer may be obtained in many ways, e.g., from a history dataset of the consumer, from metadata of the consumer, or from currently measured consumption rates if the consumer is already running.

However, the primary resource does not necessarily have to be constant during the whole duration of the allocation routine. The setting of a particular resource does not have to be controlled by a human (e.g., an administrator of the computing environment), but may likewise be performed by an algorithm implementing a portion of the method. Setting a resource as the primary resource for a portion of the allocation routine may be useful for structuring the allocation process. For instance, the resources may take turns in being set as the primary resource, as explained further below.

In an example, the selection of a number of the chunks obtained for the primary resource comprises, for the respective consumer:
determining a weight as a ratio of the expected consumption rate for the primary resource by the respective consumer to a sum of the expected consumption rate for the primary resource over all consumers; and
selecting the number of the chunks by approximating a product of the weight and a currently available quota of the primary resource.

This may ensure that the quota the consumer obtains from the primary resource, compared to the currently available quota of the primary resource, is nearly the same as the utilization of the primary resource that can be expected for the consumer compared to the expected utilization of all consumers taken together. The currently available quota of the primary resource may be a portion of the predicted available quota that may be obtained by subtracting portions of the predicted available quota that have already been packaged (during the current run of the allocation routine) from the predicted available quota. For instance, subtracted portions may be quotas that have already been added to the resource package as minimum quotas described above, or quotas of the primary resource that have been added to the resource package as a dependent resource at an earlier time in the current run of the allocation routine when another resource was set as the primary resource. However, the allocation routine may be configured to ensure that the currently available quota of the primary resource remains constant for a current section of the allocation routine, e.g., as long as the current primary resource is still set as the primary resource. It may be feasible to approximate the product of the weight and the currently available quota from below, e.g., by determining the largest number of chunks that is still below the product, to ensure that there is still a sufficient number of chunks available for other consumers for which the addition of chunks of the primary resource has not been conducted yet. If no addition of further chunks of the primary resource to the currently generated packages is planned for the current run of the allocation routine, the approach of approximating the product of the weight and the currently available quota of the primary resource may yield a (nearly) full consumption of the predicted available quota by the package generation.

In an example, the generation of the resource package further comprises a loop over the plurality of resources with a current resource assumed by the loop being set as the primary resource, the generation of the resource package comprising skipping the selection of a number of the chunks obtained for resources previously set as the primary resource during a current run of the loop. By looping over the plurality of resources, the consumer may get a rich mixture of resource quotas from the different resources that may allow for a more flexible operation of the consumer. Taking turns as the primary resource and skipping previous primary resources may be illustrated by the following theoretical example. In the example, access to four resources A, B, C, and D is distributed among a set of consumers on a subsequent layer. In a first iteration of the loop, resource A is set as the primary resource and for each consumer, a sufficient number of ‘A’ chunks is added to the respective resource package together with ‘B’, ‘C’, and ‘D’ chunks according to the entries of the correlation matrix denoting the respective dependencies of B, C, and D relative to A. The first iteration may result in a nearly full consumption of the available ‘A’ chunks. In a second iteration of the loop, resource B is set as the primary resource and for each consumer, a sufficient number of ‘B’ chunks is added to the respective resource package together with ‘C’, and ‘D’ chunks according to the entries of the correlation matrix denoting the respective dependencies of C, and D relative to B. The second iteration may result in a nearly full consumption of the available ‘B’ chunks. This may be continued in a third iteration of the loop with C as the primary resource and extra ‘D’ chunks dependent on C, and a final fourth iteration of the loop where only ‘D’ chunks are packaged. The theoretical example may demonstrate that each consumer may obtain a sufficient quota of each resource taken alone, and additional quotas of each resource that take into account the requirement of each resource for additional resources, as represented by the correlation table.

In an example, the subdivision of the available quota is adapted for ensuring that a number of chunks provided by the subdivision for a current resource is larger than a number of consumers in the plurality of consumers by at least a predefined quantity. This may ensure that the available chunks are fine-grained enough to obtain resource packages that are individually dimensioned to match the requirements of each consumer, but without risking performance losses for some consumers due to excessive overprovisioning of the resources for other consumers. A predefined quantity may be specified, e.g., as a number of chunks to be provided in surplus of the number of consumers, thus defining that the number of chunks to be provided be at least the surplus number plus the number of consumers, or, e.g., as a factor larger than one, thus defining that the number of chunks to be provided be at least the factor times the number of consumers. Non-limiting exemplary choices of a factor may be 2, 5, 10, 30, or 100. The choice of a surplus number may be oriented at a number of consumers that can be typically expected to operate on the second layer. The predefined quantity may be defined using a policy as disclosed herein, for instance.

In an example, the organization routine further comprises monitoring a performance indicator of the plurality of consumers, the subdivision being configured for finding a maximum of the performance indicator by applying a predefined variation of a typical size of the chunks compared to a typical size of the chunks applied during a previous repetition of the organization routine. In this manner, the size of a chunk may be set to observe a performance delta in the consumers in case the chunk is provided to the consumers. This may enable to experimentally determine a performance optimum during runtime of the consumers, and to retune the performance with each repetition of the organization routine, reacting to possible changes of resource availabilities and/or consumer configurations with a short response time. Hence, the allocator may be enabled to maximize a particular goal (e.g., reduce the CPU consumption while maximizing the disk bandwidth) of the plurality of consumers as a whole rather than just allocating resource budgets.

The typical size of the chunks may be the chunk size if the chunk size is constant for a particular resource, or may be a representative value such as an average or median over all chunk sizes obtained for a particular resource, for instance. The performance indicator may be a quantity that is aggregated over the plurality of consumers, such as an arithmetic average, a median, or another statistical function. The performance indicator may, but not necessarily, be related to the utilization of the resources by the consumers, such as a processor load, a network load, a memory usage, etc., or may be a higher-level quantity such as a quality-of-service (QOS) figure that may be based on multiple granular measurements or data points. The predefined variation may be defined as a relative quantity (e.g., 1%, 5%, etc.) or an absolute quantity in the respective unit of the resource quota to be varied (e.g., 2% of CPU load, 10 kbps network load, 500 MiB of memory capacity, etc.). The direction of each variation may be set by a known variation scheme, e.g., using an algorithm that finds an optimum set of parameter values by iterative variation. Eventually, a dynamic equilibrium may be reached where subsequent variations of the chunk sizes yield no significant performance increase. In an example, the performance indicator is monitored for only one of the consumers, or only a subset of the consumers, and the variation of the typical size of the chunks is applied so as to find a performance maximum only for those consumers for which the performance indicator is monitored. The performance indicator, the predefined variation of the typical chunk size, and/or the subset of consumers to be monitored may be defined using a policy as disclosed herein, for instance.

In an example, the allocation routine further comprises storing a history entry specific to the consumer, the history entry comprising data being selected from the group consisting of the utilization rates measured for the consumer, the correlation matrix obtained for the consumer, and a quota of a resource currently allocated to the consumer, the organization routine further comprising receiving a history dataset comprising a history entry stored by a previous execution of the allocation routine, the generation of the resource package being further based on the history dataset. Instead of relying on assumptions for typical utilization rates, correlation measures, and/or allocated resource quotas, this may yield a more empirically-based resource allocation for consumers whose resource utilization behavior and/or whose characteristic interdependencies of resource utilization are not known during a present execution of the organization routine. For instance, the allocator or a process close to a particular consumer may create a timetable as the history dataset that may include the resource utilization, the relationship among the resources specific to that consumer, and/or resource quotas currently allocated to the consumer at the time of recording the history dataset. The allocator may afterwards make decisions about the generation of the resource package, about a number of spare chunks to be allocated to a consumer that is newly added to the plurality of consumers, etc. based upon the resource utilization rates, the correlation measures, and/or the allocated resource quotas recorded in the timetable for an earlier instance of a current consumer. For instance, if multiple history datasets recorded at different points in time are available for a particular consumer, the allocator may analyze the recorded history entries to determine typical, maximum, or minimum values of resource utilization, correlation, or allocation assumed by earlier instances of that consumer, or may determine an aggregated quantity such as an average or median value, a sum, etc. of corresponding values contained in different history entries.

It may be possible to apply the proposed method also to non-traditional resources. One example may include electricity, which may be treated as a resource at a datacenter-wide layer. For instance, the available electricity may be distributed among the machines running in a datacenter. In other terms, datacenter may form the first layer in an analogous manner to the host layer mentioned in other application examples herein, and the machines may be treated in an analogous manner as the virtual applications in these application examples. The available electricity may be estimated using the resource model or may be provided by an administrator of the datacenter layer. The electricity may be packaged along with other correlated resources such as Ceph storage bandwidth, etc.

In another example, the number of IBM Cloud Kubernetes Service (IKS) clusters that can be set on Kernel Virtual Machine (KVM) guests may also be treated as a resource. When the host layer (e.g., a z14 machine on which the KVM guests are running) distributes the resources like disk bandwidth, CPU, network bandwidth etc. to an LPAR that will host the KVM guest, the generated resource package may also include the number of KVM guests. Thus, when the proposed solution is executed as the machine level, a resource package for each individual LPAR may contain not only the CPU, disk and network bandwidths, but also the number of IKS clusters that may be hosted on the LPAR. In this example, IKS is treated as a resource that may be distributed to an end-user level.

Another example of non-traditional resources may be a network latency. The network bandwidth and latency may depend upon multiple factors like the size of the network packets created by the consumers, the frequency of the packets being used by the consumers, etc. Similarly, the bandwidth or the transactions per second of a crypto card (hardware security module, HSM) or other hardware accelerators such as a data compression module may be dependent upon the size of the packets sent by the consumers to these devices. Some hardware accelerators may produce lower operation rates with larger packets and vice versa.

Another example may relate to allocations of clock frequency and/or electrical power to hardware units (e.g., CPUs, hardware accelerators, I/O cards, etc.). The frequency/power allocated to hardware like an x86 box may depend upon usage patterns of the hardware. For example, if the applications on the x86 box are doing a lot of I/O, then this x86 box may consume more power and/or require a higher clock frequency.

For further illustration, some application examples are given in the following.

One application example concerns a method comprising:
Receiving a request to allocate resources to components in a layer of a cloud infrastructure by dividing the resource budget of an underlying layer into chunks of different sizes;
Using a machine learning algorithm to determine an appropriate amount of resource budget that can be allocated by the underlying layer among the components of the layers it is supporting;
Converting the available resources of the underlying layer into chunks that can then be budgeted to the components in the layers it is supporting;
Determining a relationship among different kinds of resources used by the components of the layers; and
Based upon a policy, combining different kinds of chunks into packages that can be allocated to each component of the layer from the underlying layer.

A further application example concerns a method to identify a maximum quota of a resource being available at the underlying layer by:
Running tests on the resource to gather performance statistics;
Using a machine learning algorithm to determine the size of resources given the machine and application configurations; and
Tuning the estimate of the size of the resource by periodically adjusting the machine learning algorithm.

A further application example concerns a system to determine a relationship between resource usages via:
Examining the underlying layer's resource usage profile of individual components in the layers it is supporting; and
Determining whether the resource utilization of a component in a layer is positively or negatively dependent, or independent of other resources of the underlying layer.

A further application example concerns a system to combine chunks of resources based upon:
A policy introduced by a cloud administrator that determines the size of a chunk for each resource of the underlying layer, the number of components in the layer that can be hosted by the underlying layer, and a most important resource to distribute;
A packaging scheme that combines the chunks of the resources based upon the policy, the input from the machine learning algorithm and the correlation among the resources; and
A scheme to allocate the packages to the components of the layers by changing the configuration and the limits imposed on the components of the layers.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as the method 150 of organizing utilization of a plurality of resources in a computing environment disclosed herein. In addition to block 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

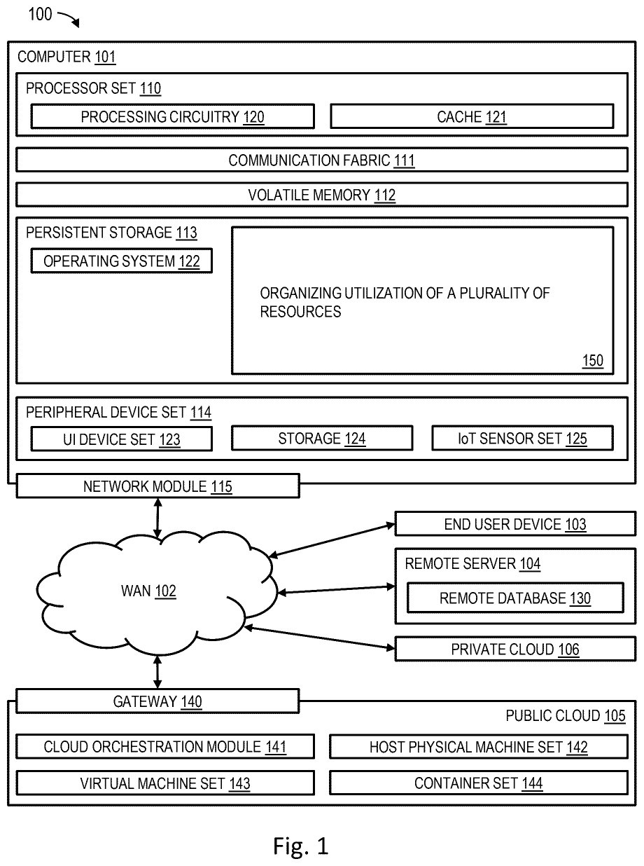

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip”. In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

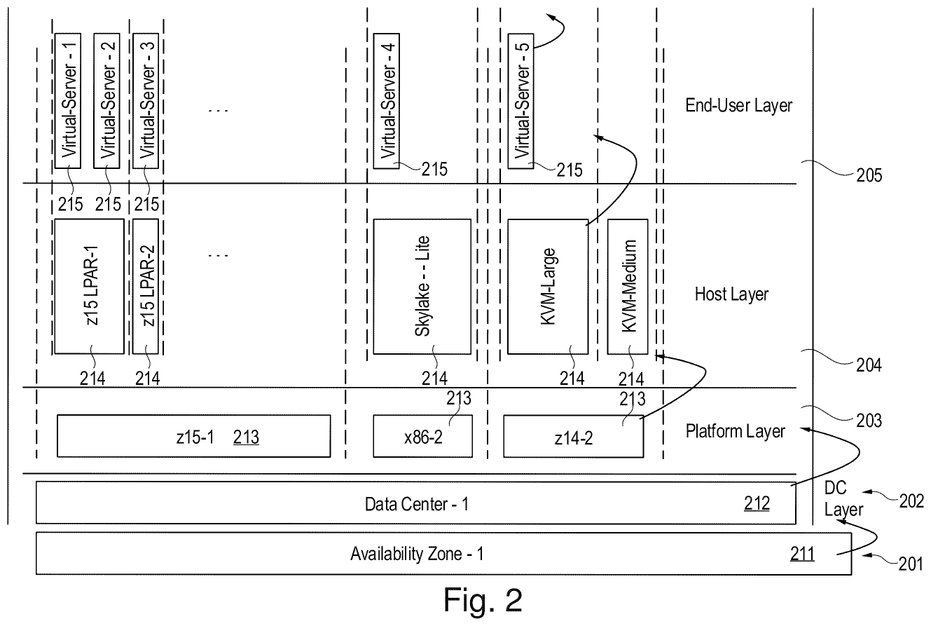

FIG. 2 is a block diagram illustrating layers of an exemplary computing environment 200. Computing environment 200 may include one or more data centers 2121 that are connected to a network (e.g., a computing cloud) where external resources are available. Logically, the space of resources externally available to a data center 2112 is referred to as an availability zone 211 which, in the exemplary layer model illustrated by FIG. 2, populates an availability zone layer 201. In the example of FIG. 2, the layer model defines a hierarchy where the availability zone layer 201 is the lowermost layer. The next higher layer is the data center layer 202 that is populated by the data center 212. The data center 212 on data center layer 202 may receive resource quota from the availability zone 211 on availability zone layer 201. Likewise, the availability zone 211 may host an allocator process (illustrated by an arrow on the right-hand side of the drawing) distributing resource quota from the availability zone layer 201 to the data center 212 as a consumer running on data center layer 202.

Similarly, data center 212 may operate one or more computer systems 213 that may implement different computing platforms and may populate a platform layer 203 ranking next higher in the hierarchy. The computer systems 213 on platform layer 203 may receive resource quota from the data center 212 on data center layer 202. Likewise, the data center 212 may host an allocator process (illustrated by an arrow on the right-hand side of the drawing) distributing resource quota from the data center layer 202 to the computer system 213 as consumers running on platform layer 203. Analogously, one or more hosts or partitions 214 may be running on each computer system 213 and may populate a host layer 204 ranking next higher in the hierarchy. The hosts 214 on host layer 204 may receive resource quota from the respective computer system 213 on platform layer 203. Likewise, one or more of the computer systems 213 may each host an allocator process (illustrated by an arrow on the right-hand side of the drawing) distributing resource quota from the platform layer 203 to the hosts 214 as consumers running on host layer 204. In a similar manner, one or more virtual servers 215 may be running on each host 214 and may populate an end-user layer 205 ranking next higher in the hierarchy. The virtual servers 215 on end-user layer 205 may receive resource quota from the respective host 214 on host layer 204. Likewise, one or more of the hosts 214 may each host an allocator process (illustrated by an arrow on the right-hand side of the drawing) distributing resource quota from the host layer 204 to the virtual servers 215 as consumers running on end-user layer 205. The same concept may be applied on even further layers not shown in the drawing, where, e.g., one or more virtual servers 215 may each host an allocator process (illustrated by another arrow on the right-hand side of the drawing) distributing resource quota among a set of applications running on the respective virtual server 215 as consumers on a subsequent application layer of the computing environment. Each allocator process may implement at least a portion of the method disclosed herein for distributing quotas of resources available on the layer where the allocator is running to a plurality of consumers running on a subsequent layer of the computing environment.

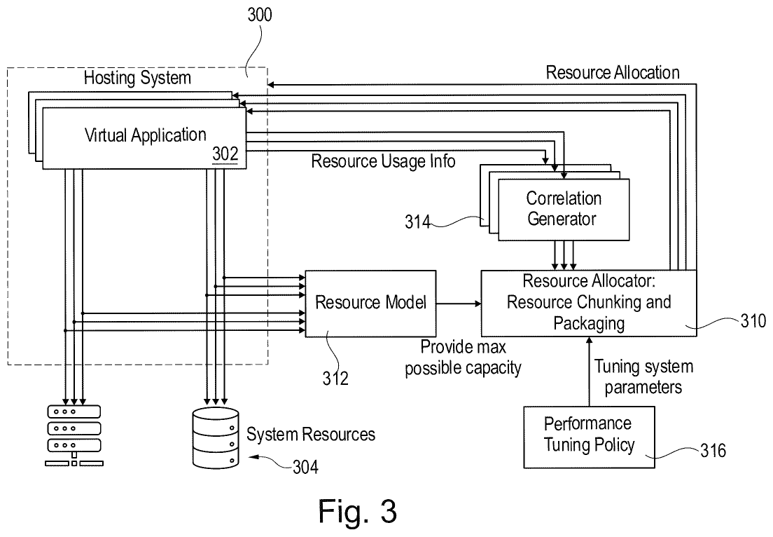

FIG. 3 is a block diagram depicting an exemplary set of modules involved in organizing utilization of a plurality of resources in a computing environment. Exemplary choices made for illustration purposes only include that a distribution of resource quotas from a hosting system 300 to a plurality of virtual applications 302 is discussed, and that the resource model 312 and a plurality of correlation generators 314 are shown as modules operating separate from the resource allocator 310. It is understood that various other configurations may be possible to implement portions of the method disclosed herein.

In the example of FIG. 3, a hosting system 300 may host a plurality of virtual applications 302. The virtual applications 302 may have access to a plurality of system resources 304, but access to the resources 304 is limited for each virtual application 302 to a quota specifically set for each application 302 and each resource 304. For that purpose, a total quota of each resource 304 that is available to the host 300 may be distributed among the applications 302 as consumers of the resources 304. The total available quota for each resource may be determined by a resource model 312. The resource model 312 may be configured for receiving or retrieving configuration parameters of the virtual applications 302 that may influence the available quota of one or more of the resources 304. Based on the configuration parameters, the resource model 312, which may be thought of as an arithmetic of numeric model or a trained machine learning model, may provide a prediction of the actually available quota of each resource 304. An exemplary output of a resource model 312 may be the resource totals 702 shown in the second column of the resource table 700 in FIG. 7.

Furthermore, each virtual application 302 may have assigned a correlation generator process 314 that may be configured to measure samples of the utilization rates 506 realized by the virtual applications 302 by using the resources 304. Each correlation generator 314 may implement, e.g., statistical functions to determine correlation measures 606 measuring a degree to which a change of utilization for one of the resources 304 is typically accompanied by a change of utilization for another one of the resources 304. The output of a correlation generator 314 may be a correlation matrix 600 containing the correlation measures 606 for all combinations of resources 304. An exemplary set of measured utilization rates 506 is depicted in table 500 of FIG. 5, and an exemplary set of correlation measures 606 is depicted in the correlation matrix 600 of FIG. 6.

The output of the resource model 312 and the outputs of the correlation generators 314 may be used as inputs to a resource allocator process 310. The allocator 310 may be configured to generate a set of resource packages based on the total resource quota 702 predicted by the resource model 312, and on the correlation matrices 600 determined by the correlation generators 314, where each resource package may be specific to one of the consumers 302. More particularly, the allocator 310 may be configured for logically subdividing the predicted total quota 702 into chunks and selecting, for each of the consumers 302 based on the correlation matrix 600 specifically determined for the respective consumer 302, a specific number of these chunks to be included in the resource package to be allocated to the respective consumer 302. Once all resource packages have been generated, the completed resource packages may be allocated to the virtual applications 302.

The resource allocator 310 may further receive a policy 316 as an additional input. The policy 316 may define parameters that may allow, e.g., an administrator to control details of the chunking and/or the packaging as disclosed herein. A further additional input to the allocator 310 (not shown in the drawing) may be a history dataset that may contain information about resource utilization rates, allocated resource quota and/or correlation tables that were used, set or determined during operation of earlier instances of the consumers 302.

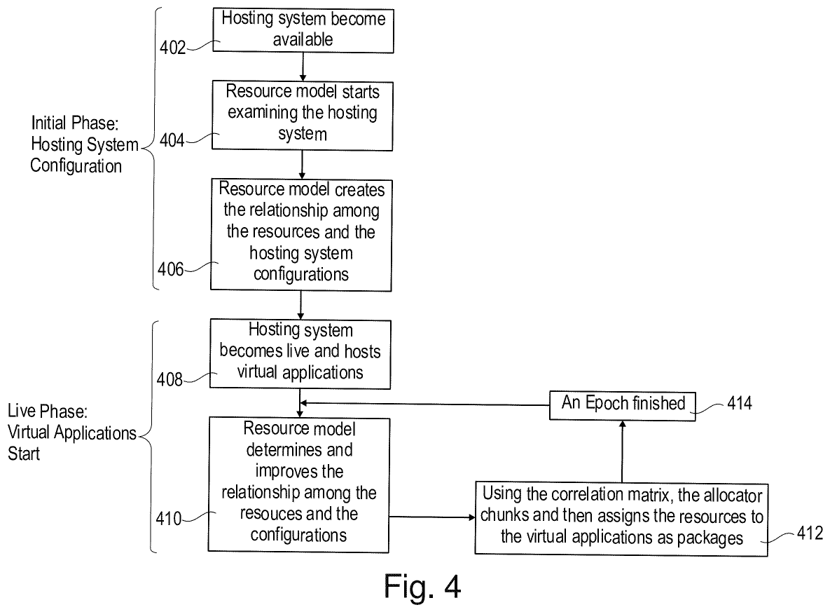

FIG. 4 is a block diagram illustrating an exemplary time sequence of resource model operations in the course of organizing utilization of a plurality of resources in a computing environment. The sequence may be divided in an initial phase containing steps (402 to 406) potentially executed by the resource model while no consumer is running, and a live phase containing steps (408 to 414) potentially executed by the resource model and related other modules while consumers are running. In the non-limiting example of FIG. 4, the first layer from where resource quota may be distributed is again a host layer, and the second layer where consumers receiving the resource quotas may be running is again an end-user layer, with the consumers being virtual applications. The initial phase may be triggered by the hosting system starting up or otherwise becoming available (step 402). Before the hosting system starts hosting any virtual applications, the resource model may execute an initialization routine. In an example, an initialization of the resource model may include invoking 404 a plurality of test configurations on the hosting system (e.g., by setting configuration parameters of the hosting system accordingly and/or launching test workloads having a known configuration). In the example, the resource model may observe a response of the hosting system or other components of the computing environment to each test configuration and tune free parameters of the resource model (e.g., by approximating coefficients, approximating synaptic weights, etc.) according to the observed responses (step 406).

The live phase may be triggered by the hosting system becoming live 408 and starting to host virtual applications. The initialization of the resource model may be finished at this point, and the resource model may generate an output indicating available quotas of resources at the host layer based on the present configuration of the hosting system and the initialization of the resource model. However, the resource model may continue to fine-tune 410 its state by observing further responses of the hosting system and/or the computing environment to present configurations of the running virtual applications. Doing so, the resource model may improve its predictive power, taking into account effects of running consumers that were not observable during the initial phase. In the example of FIG. 4, the live phase may be structured to include multiple measurements of resource utilization rates and multiple observations of responses to configuration changes. This may be performed in time intervals also referred to herein as sampling intervals. Meanwhile, the allocator may use 412 the output of the resource model and the correlation matrices obtained for the different virtual applications to generate chunks of the available resource quotas and to select specific numbers of the chunks for inclusion into resource packages to be allocated to the different virtual applications. After a predefined time (also referred to herein as the epoch time interval), the chunking, packaging and resource allocation (together also referred to herein as the organization routine) may be repeated 414, making use of updated correlation matrices reflecting a recent resource utilization behavior of the consumers and making use of possibly improved total quota predictions provided by the refined resource model.

FIG. 5 depicts a table 500 containing an exemplary timeline of utilization rates 506 measured for different resources. For the sole purpose of illustration, utilization rates 502 of disk memory “Disk Util”, processing capacity “CPU Util”, and network load “Net Util” are displayed as columns of the table 500. The rows of the table are formed by sample datasets 504 that may contain an identifier illustrated in the leftmost column, further metadata not shown such as a timestamp and/or information about the consumer for which the utilization rates 506 were measured, and the measured utilization rates 506 pertaining to the different resources. For instance, the measured utilization rates 506 may be used to determine a correlation matrix 600 for this consumer.

FIG. 6 depicts an exemplary correlation matrix 600 obtained for a particular consumer. The columns 602 and rows 604 of the correlation table denote the different resources, out of which again a disk memory “Disk Util”, a processing capacity “CPU Util”, and a network load “Net Util” have been chosen for the sole purpose of illustration. Entries 606 of the correlation table 600 may be correlations or other correlation measures of utilization rates of the respective resources shown in the column and row captions. Without limitation, the correlation measure 606 of each utilization rate relative to itself is shown as normalized to one. Furthermore, only the lower left half of the correlation table 600 is populated in the example of FIG. 6, assuming that the correlation of a resource A relative to a different resource B is the same as the correlation of resource B relative to resource A. However, this does not necessarily have to be the case in practice, as, for instance, one unit of change of CPU utilization may cause a particular value “x” of change in network load, but a change of “x” in the network load may not necessarily cause exactly one unit of change in CPU utilization. In the example of FIG. 6, a value tending towards +1 shows a positive correlation. For example, the correlation between disk utilization and network utilization is +0.5. This may mean that the disk utilization and the network utilization for this consumer grow simultaneously. Similarly, a correlation value tending towards −1 shows a negative correlation. As seen, the disk utilization and the CPU utilization for this virtual application is −0.3. This may mean that if one of the utilization rates increases, the other may decrease. A correlation value close to 0 may mean that the two resource utilizations are independent. The correlation measures 606 may be used by an allocator process when generating a resource package for that consumer, to determine which amount of chunks of a different resource should be added to a specific number of chunks of a given resource.

FIG. 7 depicts an exemplary resource table 700 containing information about chunks obtained for different resources. From left to right, the resource table 700 contains a first column 701 denoting resource identifiers, a second column 702 containing total available quota of resources as predicted by a resource model, a third column 704 containing representative chunk sizes realized for the specific resources, a fourth column 706 containing the total number of chunks obtained from the predicted total available quota 702 using the chunk size 704, and a fifth column 708 denoting a currently available number of chunks for each resource. The rows 710 of the table 700 are formed by the different resources 701. The resource table 700 may be initialized by the resource model and the process responsible for the logical subdivision of the available quota 702 into chunks, and may be used and updated by the allocation routine to keep track of the available chunks 708 for each resource during the generation of the resource packages.

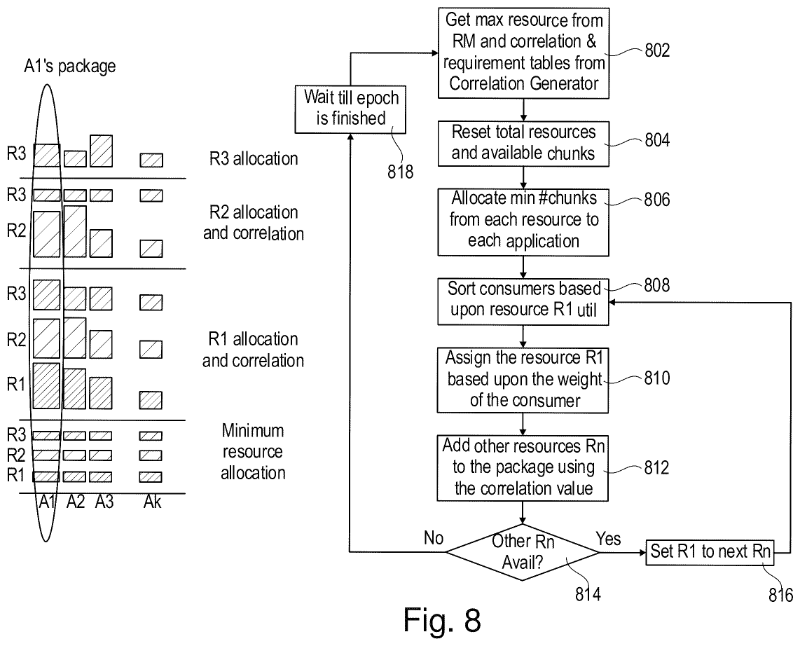

FIG. 8 is a diagram illustrating an exemplary sequence of steps that may be performed in the course of an allocation routine to effect a generation of a resource package for each consumer. It is understood that the specific combination of features set forth under the following steps has been chosen for the sole purpose of illustration and may not be construed as limiting the scope of the invention. The exemplary sequence may start with a step 802 of the allocator receiving predictions of an available quota for each resource as an output of the resource model and receiving a correlation matrix for each consumer from the correlation generator(s). Without limitation, the specific example of FIG. 8 may also include receiving a requirement table specifying for each consumer a typical utilization rate of each resource assumed by the consumer. The allocator may continue with a step 804 of newly generating a resource table 700, which may include logically subdividing the predicted available quotas into chunks. The allocator 806 may continue with a step 806 of adding chunks corresponding to a respective minimum quota of each resource to a previously empty resource package for each consumer. The minimum quotas may be obtained from metadata of the respective consumer for which the current resource package is generated, or may be set to default values if no such metadata exists for that specific consumer. The minimum quota may be measured to match requirements of the consumer ensuring that the consumer is able to function at all.

The allocator may continue by starting or resuming a loop effecting an addition of further chunks to the resource packages. Each iteration of the loop may comprise setting one of the resources as a primary resource. In the following, a first resource R1 is assumed to be set as the primary resource. The loop may comprise a step 808 of sorting the consumers by their respective typical utilization rate of R1 as indicated by the requirement table. In this way, the resource allocator may know which application is most heavily dependent upon the presently set primary resource. Moreover, the resource allocator may generate a weight for each consumer specific to resource R1. In a non-limiting example, the weight of a consumer C1 with respect to a resource R1 may be defined as the ratio of the typical utilization rate of R1 by C1 (as specified by the requirement table) to the sum of the typical utilization rates for all consumers:

$$weight\_C1 \_R1 = R1\_requirement \_C1 / sum\_of \_R1 \_requirements \_by \_all \_consumers$$

Using this weight function, chunks of the resource R1 may be added 810 to the performance package of each consumer. For example the number of chunks may be selected by approximating the following theoretical quotas from below:

$$C1\_R1 = weight\_C1 \_R1 * currently\_available \_quota \_of \_R1 , \\ C2\_R1 = weight\_C2 \_R1 * currently\_available \_quota \_of \_R1 , etc .$$

where the theoretical quota of a consumer Cm for a resource Rn may be defined as the product of the weight of consumer Cm with respect to resource Rn and the currently available quota 708 of resource Rn.

Afterwards, other resources (R2, R3, . . . ) may be added 812 to the resource packages according to their relation to R1, as specified by their respective correlation measures 606. For example, assume that 10 chunks of the current primary resource R1 have been added to the resource package for a particular consumer C1, i.e.:

$$C1\_R1 = 10 .$$

According to the correlation matrix for consumer C1, another resource R2 is correlated to R1 with a correlation measure of 0.5. Therefore, the example may include assigning 50% of the R1 chunks that were assigned to C1 as R2 chunks:

$$C1\_R2 = 10 * 0.5 = 5$$

It is understood that other (e.g., nonlinear) functions may be used to translate a particular correlation measure into a corresponding number of chunks. It is understood further that a negative correlation measure may effect a removal of chunks from a given resource package, and that chunks that were added to a resource package to ensure a minimum quota may be exempt from such removal of chunks. The allocator may continue to add or subtract chunks of further resources (R3, . . . ) to or from each resource package according to the correlation matrix in an analogous manner.

Step 814 may include a criterion controlling the loop over all resources, e.g., checking whether there is another resources that has not yet been set as the primary resource during the current run of the loop. If this is true, another resource (e.g., R2) may be set 816 as the new primary resource, with R1 being reset to the status of a non-primary resource, and the loop may start a new iteration at step 808. A new iteration may skip R1 (and any potential other resources that were already set as the primary resource during the current run of the loop) from the generation of the resource packages. For instance, the consumers may be sorted 808 by their typical consumption of R2, chunks of R2 may be added to the resource packages according to their respective weights, and the resources R3, R4, . . . may be added depending upon the number of chunks determined for R2 according to their respective correlation measures. Afterwards, the process may be iterated with R3 being the primary resource, etc. The presently discussed approach of sorted resource packaging is illustrated by the box diagram on the left-hand side of FIG. 8. At the end, each virtual application may get allocated its own resource package that may contain minimal functional chunks; chunks of all the resources based upon distributing the resource R1; chunks of all the resources based upon distributing the resource R2, chunks of all the resources based upon distributing the resource R3, etc.

FIG. 9 depicts an exemplary code sample 900 defining contents of a resource package. In the example of FIG. 9, an XML expression or a similar struct phrased in an appropriate programming language may used to define a resource package containing an identifier for each packaged resource type (e.g., “disk”, “network”, “compute”, crypto”, etc.), and one or more statements each denoting an identifier of a particular resource under each resource type together with an assignment of a resource quota corresponding to the respectively determined number of chunks for that particular resource (e.g., “50 MB/s” for the resource disk bandwidth under resource type “disk”, “100 Mbps” for the resource network bandwidth under resource type “network”, etc.). The statement defining the resource package may be transmitted to a process configured for controlling execution or otherwise operation of the consumers. For instance, the package may be provided to a cloud manager, which reads the package and then limits the disk, network, computing, . . . bandwidths on individual consumers. For example, if the consumers are virtual applications using a KVM hypervisor, the cloud manager may tune the XML files of the KVM guests and add these resources as limits for the KVM guests. A QEMU emulator, for instance, may then ensure that these limits are respected by the KVM guests.

In the following, examples illustrating notions of the invention will be described again by a list of clauses highlighting several possible, non-exclusive combinations of features disclosed herein:
1. A computer-implemented method of organizing utilization of a plurality of resources in a computing environment, the computing environment being logically partitioned in layers, the method comprising executing, by a computer system being operatively coupled to the computing environment and being configured for implementing a first one of the layers, an organization routine comprising:
   identifying a plurality of consumers of the resources on a second layer subsequent to the first layer;
      for each of the resources:
         obtaining from a resource model a prediction of an available quota of the resource based on a configuration of the consumers;
         logically subdividing the available quota into chunks;
      executing an allocation routine comprising, for each of the consumers:
         obtaining a correlation matrix of utilization rates of each resource measured for the consumer;
         generating a resource package specific to the consumer, the generation of the resource package comprising selecting, based on the correlation matrix, a number of the chunks obtained for each resource, and adding the selected chunks to the resource package; and
         allocating the resource package to the consumer.
2. The method of clause 1, further comprising initializing the resource model based on responses of the respective resource to variations of the configuration.
3. The method of clause 2, the resource model being a machine learning model, the initialization of the resource model comprising training the machine learning model using a training dataset incorporating the variations of the configuration and the corresponding responses of the resource.
4. The method of clause 2 or 3, the configuration comprising a numeric configuration parameter of the consumers, the resource model expressing the available quota as a mathematical function of the configuration parameter, the initialization of the resource model comprising determining a coefficient of the configuration parameter in the mathematical function.
5. The method of one of clauses 2 to 4, the initialization of the resource model being completed before a startup of the consumers, the organization routine further comprising, after the startup of the consumers, obtaining a recent value of the available quota for one of the resources, and adjusting the resource model based on the recent value of the available quota and the configuration of the consumers.
6. The method of any of the previous clauses, further comprising receiving a policy, the organization routine being adapted for applying the policy, the policy comprising a requirement selected from the group consisting of: a number of the chunks to be provided by the subdivision; a size of the chunks to be provided by the subdivision; a priority of a consumer for the selection of a number of the chunks; a priority of a resource for the selection of a number of the chunks; and a nominal number of repetitions of measurements of the utilization rates to be completed before triggering a further execution of the organization routine.
7. The method of any of the previous clauses, the allocation routine further comprising, for each of the consumers, obtaining a requirement table based on the utilization rates measured for the consumer, the requirement table comprising a typical utilization rate of each resource assumed by the consumer, the generation of the resource package being further based on the requirement table.
8. The method of any of the previous clauses, the organization routine being repeated according to a predefined schedule.
9. The method of clause 8, wherein a repetition of the organization routine is triggered earlier than according to the schedule in response to detecting fulfilment of a predefined condition being selected from the group consisting of a peak utilization of one of the resources, and an addition of a new consumer to the plurality of consumers.
10. The method of any of the previous clauses, the organization routine being repeated in response to identifying an addition of a new consumer to the plurality of consumers.
11. The method of any of the previous clauses, the allocation routine further comprising generating a spare resource package, the generation of the spare resource package comprising selecting a number of the chunks obtained for each resource as spare chunks to be withheld from the allocation of the resource packages, and adding the selected spare chunks to the spare resource package, the allocation routine further comprising, in response to detecting a peak utilization of one of the resources by one of the consumers, allocating a spare chunk of the resource subject to the peak utilization to the consumer causing the peak utilization, and in response to an addition of a new consumer to the plurality of consumers, allocating a spare chunk of each resource to the new consumer.
12. The method of any of the previous clauses, the generation of the resource package being adapted for ensuring that the resource package contains at least a minimum quota of the current resource predefined for the consumer.
13. The method of any of the previous clauses, the allocation routine further comprising setting a resource from the plurality of resources as a primary resource, and defining a packaging order by sorting the consumers by an expected consumption rate being expected for the primary resource by the respective consumer, the generation of the resource package for each of the consumers being performed in the packaging order with the selection of a number of the chunks obtained for each resource comprising for the respective consumer: selecting a number of the chunks obtained for the primary resource based on the expected consumption rate for the consumer, and selecting a number of the chunks obtained for another resource based on the correlation table and the expected consumption rate for the consumer.
14. The method of clause 13, the selection of a number of the chunks obtained for the primary resource comprising, for the respective consumer:
   determining a weight as a ratio of the expected consumption rate for the primary resource by the respective consumer to a sum of the expected consumption rate for the primary resource over all consumers; and
   selecting the number of the chunks by approximating a product of the weight and a currently available quota of the primary resource.
15. The method of clause 13 or 14, the generation of the resource package further comprising a loop over the plurality of resources with a current resource assumed by the loop being set as the primary resource, the generation of the resource package comprising skipping the selection of a number of the chunks obtained for resources previously set as the primary resource during a current run of the loop.
16. The method of any of the previous clauses, the subdivision of the available quota being adapted for ensuring that a number of chunks provided by the subdivision for a current resource is larger than a number of consumers in the plurality of consumers by at least a predefined quantity.
17. The method of any of the previous clauses, the organization routine further comprising monitoring a performance indicator of the plurality of consumers, the subdivision being configured for finding a maximum of the performance indicator by applying a predefined variation of a typical size of the chunks compared to a typical size of the chunks applied during a previous repetition of the organization routine.
18. The method of any of the previous clauses, the allocation routine further comprising storing a history entry specific to the consumer, the history entry comprising data being selected from the group consisting of the utilization rates measured for the consumer, the correlation matrix obtained for the consumer, and a quota of a resource currently allocated to the consumer, the organization routine further comprising receiving a history dataset comprising a history entry stored by a previous execution of the allocation routine, the generation of the resource package being further based on the history dataset.
19. A computer program product comprising a computer readable storage medium having program instructions embodied therewith, the program instructions being executable by a computer system operatively coupled to a computing environment, the computing environment being logically partitioned in layers, the computer system being configured for implementing a first one of the layers, wherein execution of the program instructions on the first layer causes the computer system to perform a method of organizing utilization of a plurality of resources in the computing environment, the method comprising executing an organization routine comprising:
   identifying a plurality of consumers of the resources on a second layer subsequent to the first layer;
   for each of the resources:
      obtaining from a resource model a prediction of an available quota of the resource based on a configuration of the consumers;
      logically subdividing the available quota into chunks;
   executing an allocation routine comprising, for each of the consumers:
      obtaining a correlation matrix of utilization rates of each resource measured for the consumer;
      generating a resource package specific to the consumer, the generation of the resource package comprising selecting, based on the correlation matrix, a number of the chunks obtained for each resource, and adding the selected chunks to the resource package; and
      allocating the resource package to the consumer.
20. A computer system comprising a processor and a memory operatively coupled to the processor, the computer system being operatively coupled to a computing environment, the computing environment being logically partitioned in layers, the computer system being configured for implementing a first one of the layers, the memory storing program instructions which, when executed by the processor on the first layer, cause the computer system to perform a method of organizing utilization of a plurality of resources in the computing environment, the method comprising executing an organization routine comprising:
   identifying a plurality of consumers of the resources on a second layer subsequent to the first layer;
   for each of the resources:
      obtaining from a resource model a prediction of an available quota of the resource based on a configuration of the consumers;
      logically subdividing the available quota into chunks;
   executing an allocation routine comprising, for each of the consumers:
      obtaining a correlation matrix of utilization rates of each resource measured for the consumer;
      generating a resource package specific to the consumer, the generation of the resource package comprising selecting, based on the correlation matrix, a number of the chunks obtained for each resource, and adding the selected chunks to the resource package; and
      allocating the resource package to the consumer.

What is claimed is:

1. A computer-implemented method of organizing utilization of a plurality of resources in a computing environment, the computing environment being logically partitioned in layers, the method comprising executing, by a computer system being operatively coupled to the computing environment and being configured for implementing a first one of the layers, an organization routine comprising:
identifying a plurality of consumers of the resources on a second layer subsequent to the first layer;
for each of the resources:
obtaining from a resource model a prediction of an available quota of the resource based on a configuration of the consumers;
logically subdividing the available quota into chunks;
executing an allocation routine comprising, for each of the consumers:
obtaining a correlation matrix of utilization rates of each resource measured for the consumer;
generating a resource package specific to the consumer, the generation of the resource package comprising selecting, based on the correlation matrix, a number of the chunks obtained for each resource, and adding the selected chunks to the resource package; and
allocating the resource package to the consumer.

2. The method of claim 1, further comprising initializing the resource model based on responses of the respective resource to variations of the configuration.

3. The method of claim 2, the resource model being a machine learning model, the initialization of the resource model comprising training the machine learning model using a training dataset incorporating the variations of the configuration and the corresponding responses of the resource.

4. The method of claim 2, the configuration comprising a numeric configuration parameter of the consumers, the resource model expressing the available quota as a mathematical function of the configuration parameter, the initialization of the resource model comprising determining a coefficient of the configuration parameter in the mathematical function.

5. The method of claim 2, the initialization of the resource model being completed before a startup of the consumers, the organization routine further comprising, after the startup of the consumers, obtaining a recent value of the available quota for one of the resources, and adjusting the resource model based on the recent value of the available quota and the configuration of the consumers.

6. The method of claim 1, further comprising receiving a policy, the organization routine being adapted for applying the policy, the policy comprising a requirement selected from the group consisting of: a number of the chunks to be provided by the subdivision; a size of the chunks to be provided by the subdivision; a priority of a consumer for the selection of a number of the chunks; a priority of a resource for the selection of a number of the chunks; and a nominal number of repetitions of measurements of the utilization rates to be completed before triggering a further execution of the organization routine.

7. The method of claim 1, the allocation routine further comprising, for each of the consumers, obtaining a requirement table based on the utilization rates measured for the consumer, the requirement table comprising a typical utilization rate of each resource assumed by the consumer, the generation of the resource package being further based on the requirement table.

8. The method of claim 1, the organization routine being repeated according to a predefined schedule.

9. The method of claim 8, wherein a repetition of the organization routine is triggered earlier than according to the schedule in response to detecting fulfilment of a predefined condition being selected from the group consisting of a peak utilization of one of the resources, and an addition of a new consumer to the plurality of consumers.

10. The method of claim 1, the organization routine being repeated in response to identifying an addition of a new consumer to the plurality of consumers.

11. The method of claim 1, the allocation routine further comprising generating a spare resource package, the generation of the spare resource package comprising selecting a number of the chunks obtained for each resource as spare chunks to be withheld from the allocation of the resource packages, and adding the selected spare chunks to the spare resource package, the allocation routine further comprising, in response to detecting a peak utilization of one of the resources by one of the consumers, allocating a spare chunk of the resource subject to the peak utilization to the consumer causing the peak utilization, and in response to an addition of a new consumer to the plurality of consumers, allocating a spare chunk of each resource to the new consumer.

12. The method of claim 1, the generation of the resource package being adapted for ensuring that the resource package contains at least a minimum quota of the current resource predefined for the consumer.

13. The method of claim 1, the allocation routine further comprising setting a resource from the plurality of resources as a primary resource, and defining a packaging order by sorting the consumers by an expected consumption rate being expected for the primary resource by the respective consumer, the generation of the resource package for each of the consumers being performed in the packaging order with the selection of a number of the chunks obtained for each resource comprising for the respective consumer: selecting a number of the chunks obtained for the primary resource based on the expected consumption rate for the consumer, and selecting a number of the chunks obtained for another resource based on the correlation table and the expected consumption rate for the consumer.

14. The method of claim 13, the selection of a number of the chunks obtained for the primary resource comprising, for the respective consumer:
determining a weight as a ratio of the expected consumption rate for the primary resource by the respective consumer to a sum of the expected consumption rate for the primary resource over all consumers; and
selecting the number of the chunks by approximating a product of the weight and a currently available quota of the primary resource.

15. The method of claim 13, the generation of the resource package further comprising a loop over the plurality of resources with a current resource assumed by the loop being set as the primary resource, the generation of the resource package comprising skipping the selection of a number of the chunks obtained for resources previously set as the primary resource during a current run of the loop.

16. The method of claim 1, the subdivision of the available quota being adapted for ensuring that a number of chunks provided by the subdivision for a current resource is larger than a number of consumers in the plurality of consumers by at least a predefined quantity.

17. The method of claim 1, the organization routine further comprising monitoring a performance indicator of the plurality of consumers, the subdivision being configured for finding a maximum of the performance indicator by applying a predefined variation of a typical size of the chunks compared to a typical size of the chunks applied during a previous repetition of the organization routine.

18. The method of claim 1, the allocation routine further comprising storing a history entry specific to the consumer, the history entry comprising data being selected from the group consisting of the utilization rates measured for the consumer, the correlation matrix obtained for the consumer, and a quota of a resource currently allocated to the consumer, the organization routine further comprising receiving a history dataset comprising a history entry stored by a previous execution of the allocation routine, the generation of the resource package being further based on the history dataset.

19. A computer program product comprising a computer readable storage medium having program instructions embodied therewith, the program instructions being executable by a computer system operatively coupled to a computing environment, the computing environment being logically partitioned in layers, the computer system being configured for implementing a first one of the layers, wherein execution of the program instructions on the first layer causes the computer system to perform a method of organizing utilization of a plurality of resources in the computing environment, the method comprising executing an organization routine comprising:
identifying a plurality of consumers of the resources on a second layer subsequent to the first layer;
for each of the resources:
obtaining from a resource model a prediction of an available quota of the resource based on a configuration of the consumers;
logically subdividing the available quota into chunks;
executing an allocation routine comprising, for each of the consumers:
obtaining a correlation matrix of utilization rates of each resource measured for the consumer;
generating a resource package specific to the consumer, the generation of the resource package comprising selecting, based on the correlation matrix, a number of the chunks obtained for each resource, and adding the selected chunks to the resource package; and
allocating the resource package to the consumer.

20. A computer system comprising a processor and a memory operatively coupled to the processor, the computer system being operatively coupled to a computing environment, the computing environment being logically partitioned in layers, the computer system being configured for implementing a first one of the layers, the memory storing program instructions which, when executed by the processor on the first layer, cause the computer system to perform a method of organizing utilization of a plurality of resources in the computing environment, the method comprising executing an organization routine comprising:
identifying a plurality of consumers of the resources on a second layer subsequent to the first layer;
for each of the resources:
obtaining from a resource model a prediction of an available quota of the resource based on a configuration of the consumers;
logically subdividing the available quota into chunks;
executing an allocation routine comprising, for each of the consumers:
obtaining a correlation matrix of utilization rates of each resource measured for the consumer;
generating a resource package specific to the consumer, the generation of the resource package comprising selecting, based on the correlation matrix, a number of the chunks obtained for each resource, and adding the selected chunks to the resource package; and
allocating the resource package to the consumer.
